(19) United States
(12) Patent Application Publication
(10) Pub. No.: US 2024/0136492 A1
(43) Pub. Date: Apr. 25, 2024

(54) MANUFACTURING METHOD OF SECONDARY BATTERY

(71) Applicant: Samsung SDI Co., Ltd., Yongin-si (KR)

(72) Inventor: Gee Woo CHANG, Yongin-si (KR)

(21) Appl. No.: 18/470,285

(22) Filed: Sep. 18, 2023

(30) Foreign Application Priority Data
Oct. 23, 2022 (KR) 10-2022-0137116

(51) Int. Cl. H01M 4/04; B08B 3/08; C09D 179/08; C11D 7/26; C11D 7/50; C11D 11/00; H01M 10/04; H01M 50/586; H01M 50/59

(52) U.S. Cl. CPC H01M 4/0402; B08B 3/08; C09D 179/08; C11D 7/266; C11D 7/5022; C11D 11/0047; H01M 10/04; H01M 10/0431; H01M 50/586; H01M 50/59

(57) ABSTRACT

A method for manufacturing a secondary battery, includes: an electrode assembly formation process in which a unit stack is wound or stacked to form an electrode assembly; a coating process in which an area of a non-coating portion including a negative electrode tab and a positive electrode tab of the electrode assembly is coated; and a cleaning process in which the negative electrode tab and the positive electrode tab are cleaned after the coating process.

### CROSS-REFERENCE TO RELATED APPLICATION

This application claims priority to and the benefit of Korean Patent Application No. 10-2022-0137116, filed on Oct. 24, 2022, in the Korean Intellectual Property Office, the entire disclosure of which is incorporated by reference herein.

### BACKGROUND

### 1. Field

Aspects of embodiments of the present disclosure relate to a method for manufacturing a secondary battery.

### 2. Description of the Related Art

In general, a secondary battery may include an electrode assembly, a case in which the electrode assembly is accommodated together with an electrolyte, and a cap assembly for sealing the case. The electrode assembly may include a separator disposed between a positive electrode plate and a negative electrode plate, and then, the separator, the positive electrode plate, and the negative electrode plate may be stacked or wound.

The electrode assembly generally includes the separator to prevent a short circuit between the negative electrode plate and the positive electrode plate from occurring. However, an insulating material may be additionally applied to a non-coating area except for a base tab to prevent the short circuit from occurring.

The above information disclosed in this Background section is for enhancement of understanding of the background of the present disclosure, and therefore, it may contain information that does not constitute prior art.

### SUMMARY

In a comparative example, before the winding or stacking of the electrode assembly, the insulating material may be applied to each of the negative electrode plate, the positive electrode plate, and the separator, and then, the electrode assembly may be wound or stacked. However, in this case, a coating process may be long (e.g., may be increased), and a production rate may be lowered (e.g., decreased).

One or more embodiments of the present disclosure are directed to a method for manufacturing a secondary battery, in which an insulating coating structure and a coating method of an electrode assembly may be improved.

According to one or more embodiments of the present disclosure, a method for manufacturing a secondary battery, includes: an electrode assembly formation process in which a unit stack is wound or stacked to form an electrode assembly; a coating process in which an area of a non-coating portion including a negative electrode tab and a positive electrode tab of the electrode assembly is coated; and a cleaning process in which the negative electrode tab and the positive electrode tab are cleaned after the coating process.

In an embodiment, the method may further include a drying process in which the electrode assembly may be dried after the coating process and the cleaning process.

In an embodiment, the coating process may include a dip coating process in which the area of the non-coating portion including the negative electrode tab and the positive electrode tab may be immersed in an insulating material solution to be coated.

In an embodiment, the insulating material solution may include polyimide (PI) or polyamide-imide (PAI).

In an embodiment, in the cleaning process, the negative electrode tab and the positive electrode tab may be immersed in a cleaning material solution to be cleaned.

In an embodiment, the cleaning material solution may include dimethyl carbonate (DMC).

According to one or more embodiments of the present disclosure, a method for manufacturing a secondary battery, includes: forming an electrode assembly in which a unit stack is wound or stacked; coating an area of a non-coating portion comprising a negative electrode tab and a positive electrode tab of the electrode assembly; and cleaning the negative electrode tab and the positive electrode tab after the coating.

In an embodiment, the method may further include drying the electrode assembly after the coating and the cleaning.

In an embodiment, the coating may include dip coating the area of the non-coating portion including the negative electrode tab and the positive electrode tab in an insulating material solution.

In an embodiment, the insulating material solution may include polyimide (PI) or polyamide-imide (PAI).

In an embodiment, the cleaning may include immersing the negative electrode tab and the positive electrode tab in a cleaning material solution.

In an embodiment, the cleaning material solution may include dimethyl carbonate (DMC).

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1A illustrates a perspective view of a secondary battery according to one or more embodiments;

FIG. 1B illustrates a perspective view of an electrode assembly of FIG. 1A;

FIG. 2A illustrates a perspective view of a secondary battery according to one or more embodiments;

FIG. 2B illustrates a perspective view of an electrode assembly of FIG. 2A; and

FIGS. 3A-3D illustrate schematic views of some processes of a method for manufacturing an electrode assembly according to one or more embodiments.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

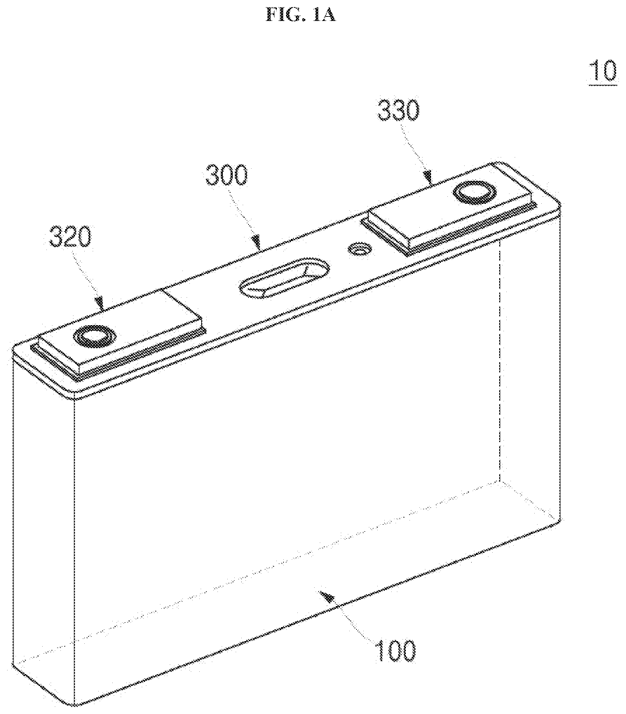

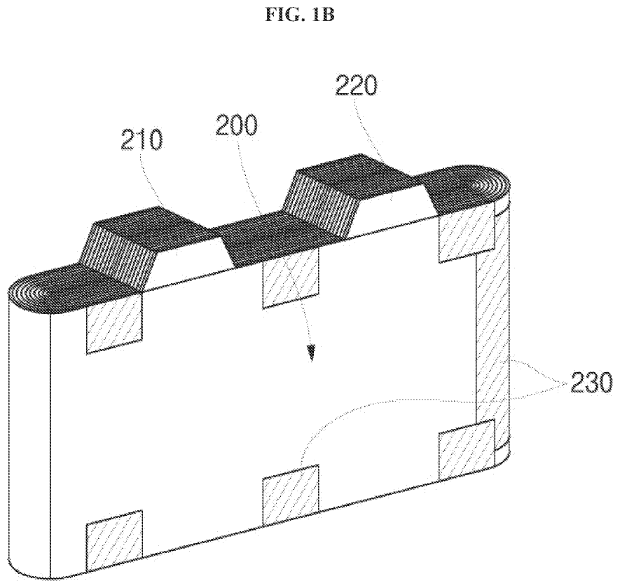

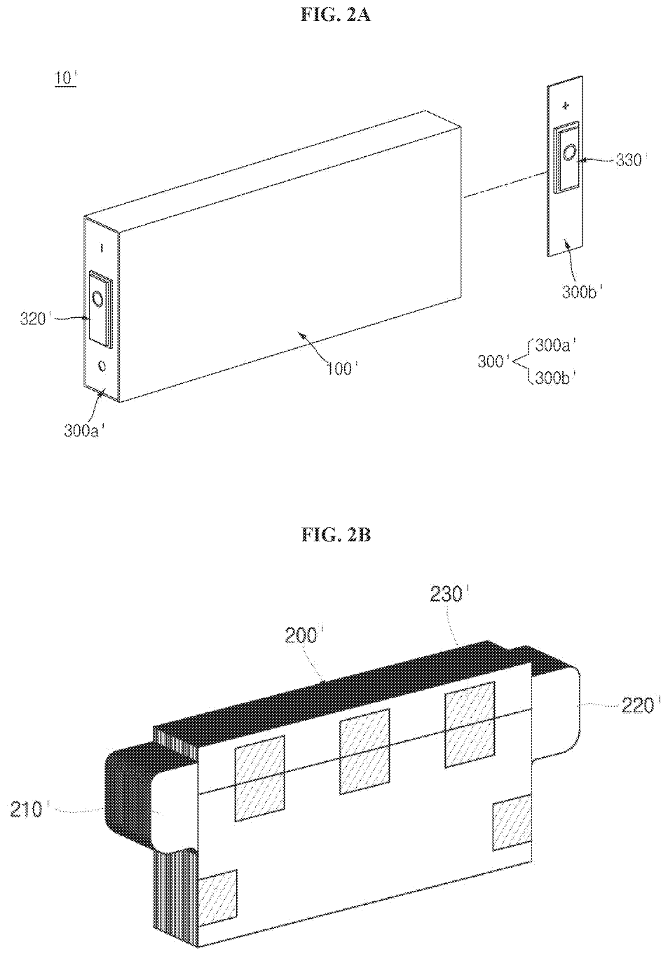

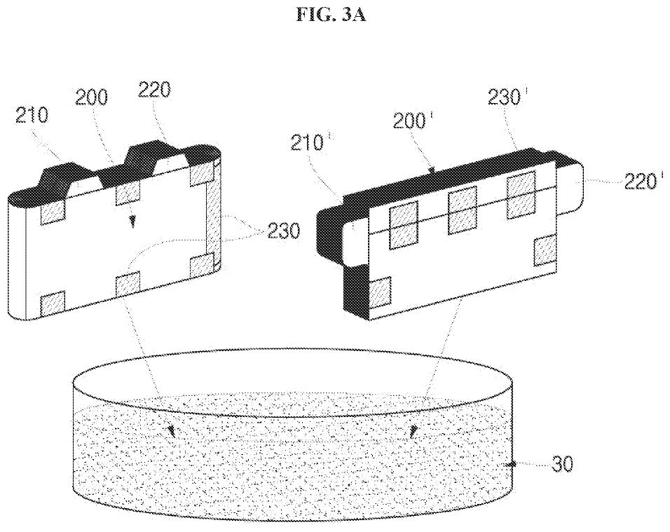

FIG. 1A illustrates a perspective view of a secondary battery according to one or more embodiments. FIG. 1B illustrates a perspective view of an electrode assembly of FIG. 1A. FIG. 2A illustrates a perspective view of a secondary battery according to one or more embodiments. FIG. 2B illustrates a perspective view of an electrode assembly of FIG. 2A.

Referring to FIGS. 1A and 1B, a secondary battery 10 according to one or more embodiments may have a suitable shape, such as a case having a rectangular parallelepiped shape in which an electrode assembly 200 is accommodated therein, and then, a cap assembly 300 is coupled thereto. The cap assembly 300 may include a negative electrode terminal part 320 and a positive electrode terminal part 330. In some embodiments, the electrode assembly 200 may be in a wound form, or in other words, in a jelly-roll form. A negative electrode tab 210 may be disposed on a negative electrode plate of the electrode assembly 200, and may be electrically connected to the negative electrode terminal part 320. A positive electrode tab 220 may be disposed on a positive electrode plate of the electrode assembly 200, and may be electrically connected to the positive electrode terminal part 330.

The electrode assembly 200 may be manufactured by winding a unit stack constituted by first and second electrode plates, each of which has a thin plate shape or a film shape, and a separator disposed between the first and second electrode plates. In some embodiments, a winding shaft of the electrode assembly 200 may be disposed in a horizontal direction that is parallel to or substantially parallel to a longitudinal direction of the case 100, or a vertical direction that is parallel to or substantially parallel to the longitudinal direction of the case 100. In some embodiments, the first electrode plate may be a negative electrode, and the second electrode plate may be a positive electrode. In some embodiment, the first electrode plate may be a positive electrode, and the second electrode plate may be a negative electrode.

When the first electrode plate is the negative electrode plate, the first electrode plate may be provided by applying a first electrode active material, such as graphite or carbon, to a first electrode collector including (e.g., made of) a metal foil, such as copper, a copper alloy, nickel, or a nickel alloy. A non-coating portion, which is an area to which the first electrode active material is not applied, may be provided on the first electrode plate. The non-coating portion may be disposed in a direction directed to (e.g., towards) the cap assembly 300. The negative electrode tab 210, which is a first base material tab, may be provided by cutting the non-coating portion except for a portion of the non-coating portion. The negative electrode tab 210 may be provided in a plurality, and the plurality of negative electrode tabs 210 may be gathered to one side of the electrode assembly 200 when wound. As described above, the negative electrode tab 210 may be electrically connected to the negative electrode terminal part 320.

When the second electrode plate is the positive electrode plate, the second electrode plate may be provided by applying a second electrode active material, such as a transition metal oxide, to a second electrode collector including (e.g., made of) a metal foil, such as aluminum or an aluminum alloy. A non-coating portion, which is an area to which the second electrode active material is not applied, may be provided on the second electrode plate. The non-coating portion may be disposed in a direction directed to (e.g., towards) the cap assembly 300. The positive electrode tab 220, which is a second base material tab, may be provided by cutting the non-coating portion except for a portion of the non-coating portion. The positive electrode tab 220 may be provided in a plurality, and the plurality of positive electrode tabs 220 may be gathered to one side of the electrode assembly 200 when wound. As described above, the positive electrode tab 220 may be electrically connected to the positive electrode terminal part 330.

The separator may be disposed between the first electrode plate and the second electrode plate to prevent or substantially prevent a short circuit, and to enable movement of lithium ions. In some embodiments, the separator may include (e.g., may be made of) polyethylene, polypropylene, or a composite film of polyethylene and polypropylene. However, the present disclosure is not limited to the above-described materials.

In some embodiments, referring to FIGS. 2A and 2B, a secondary battery 10′ according to one or more embodiments may have a suitable shape, such as a case 100′ having a rectangular parallelepiped shape in which an electrode assembly 200′ is accommodated therein, and then, a pair (e.g., 300a′ and 300b′) of cap assemblies 300′ are coupled thereto. A negative terminal part 320′ and a positive terminal part 330′ may be provided in the cap assemblies 300′. In some embodiments, the electrode assembly 200′ may be in a stacked form, or in other words, in a stack form. A negative electrode tab 210′ disposed on a negative electrode plate of the electrode assembly 200′ may be electrically connected to the negative terminal part 320′. A positive electrode tab 220′ disposed on a positive electrode plate of the electrode assembly 200′ may be electrically connected to the positive terminal part 330′.

The electrode assembly 200′ may be manufactured by stacking a plurality of unit stacks, each of which is constituted by first and second electrode plates, and a separator disposed between the first and second electrode plates. Each of the first and second electrode plates may have a thin plate shape or a film shape. In some embodiments, long side surfaces of the plurality of unit stacks and a long side surface of the case 100′ may be disposed to be adjacent to each other. The negative electrode tab 210′ and the positive electrode tab 220′ may be disposed toward the negative terminal part 320′ and the positive terminal part 330′, respectively. In some embodiments, the negative electrode tab 210′ may be disposed at one end in a longitudinal direction of the case 100′, and the positive electrode tab 220′ may be disposed at the other end in the longitudinal direction of the case 100′. In other embodiments, a stack-type electrode assembly may be applied to even a secondary battery provided with a single cap assembly. Because the electrode assembly 200′ is the same or substantially the same as that of the above-described embodiments, redundant description thereof may not be repeated.

The electrode assemblies 200 and 200′ provided in the forms of the jelly-roll or stack described above may be portions to be insulated to prevent or substantially prevent the short circuit between the negative electrode plate and the positive electrode plate from occurring. In a comparative example, before winding or stacking of the electrode assembly, the insulating material may be applied to each of the negative electrode plate, the positive electrode plate, and the separator, and then, the electrode assembly is wound or stacked. However, in this process, a coating process may be long, and a production rate may be lowered. According to one or more embodiments of the present disclosure, the electrode assemblies 200 and 200′ provided in the forms of the jelly-roll or stack may be manufactured, and then, the insulating material may be applied, such that the production rate may be greatly increased. Some of the processes of manufacturing the electrode assemblies 200 and 200′ will be described in more detail hereinafter.

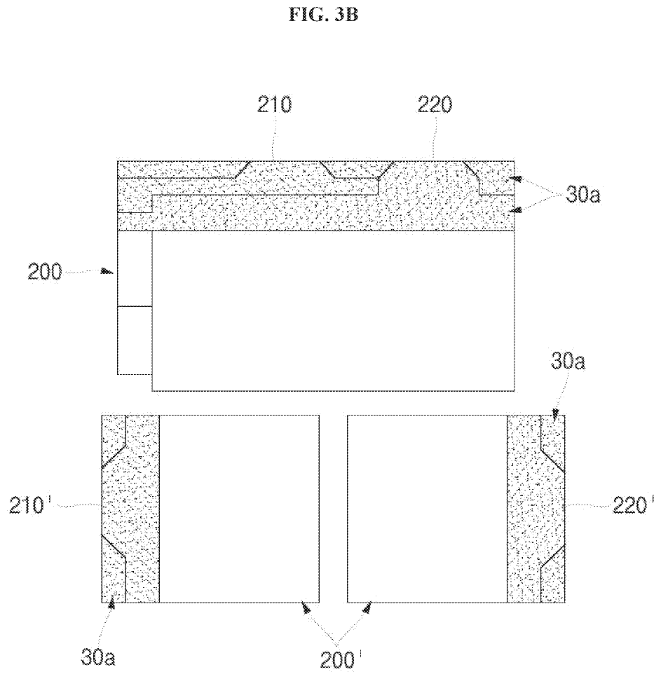

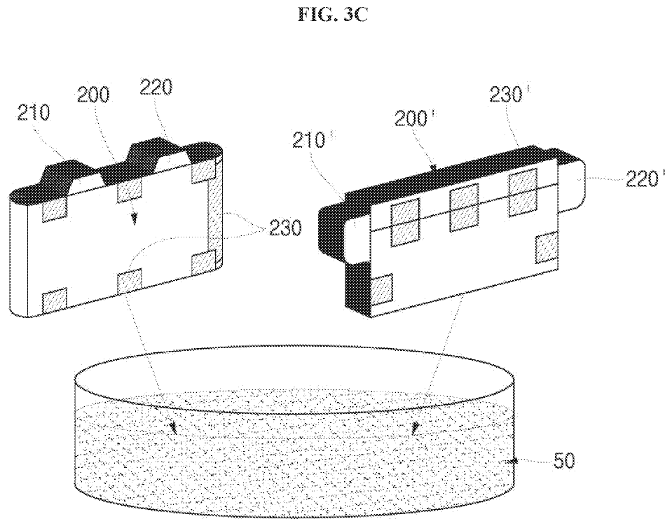

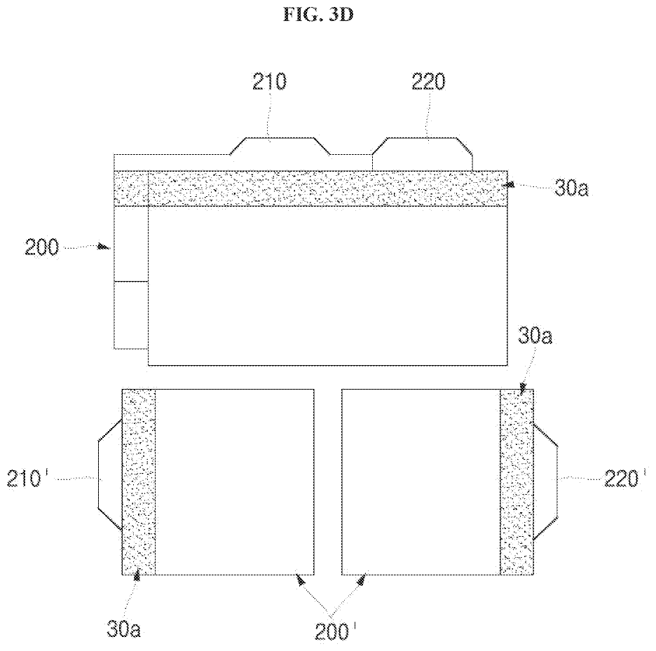

FIGS. 3A through 3D illustrate schematic views of some processes of a method for manufacturing an electrode assembly according to one or more embodiments. FIG. 3A illustrates a process of applying an insulating part of an electrode assembly, and FIG. 3B illustrates a coating area. FIG. 3C illustrates a partial cleaning process, and FIG. 3D illustrates a coating area that finally remains after the cleaning.

First, a jelly roll-type electrode assembly 200 (hereinafter, referred to as a jelly roll) or a stack-type electrode assembly 200′ (hereinafter, referred to as a stack) may be manufactured. Finishing tapes 230 or 230′ may be attached, so that the rolled or stacked form is maintained.

Thereafter, as illustrated in FIG. 3A, a portion of the jelly roll 200 or the stack 200′ may be immersed in a container containing an insulating material solution 30 to form an insulating coating part 30a. The coating method in which an object to be coated is immersed in a solution so as to be coated may be referred to as a dip coating method. In some embodiments, polyimide (PI) or polyamide-imide (PAI) may be used as the insulating material solution 30. The insulating material solution 30 may be applied to the negative electrode tabs 210 and 210′, the positive electrode tabs 220 and 220′, and an area of a remaining non-coating portion except for a portion at which the tabs are formed to form the insulating coating part 30a. An area on which the insulating coating part 30a is formed is illustrated in FIG. 3B.

A portion in which actual insulation is desired may be the area of the non-coating portion of each of the negative electrode plate and the positive electrode plate. Although a separator exists between the negative electrode plate and the positive electrode plate, when a wound or stacked state is disturbed due to an external impact, short circuit may occur due to contact between the non-coating portions. Thus, it may be desired to insulate the area of the non-coating portion of the finished products of the jelly roll 200 and the stack 200′. However, the negative electrode tabs 210 and 210′ and the positive electrode tabs 220 and 220′ are electrically connected to the negative terminal parts 320 and 320′ and the positive terminal parts 330 and 330′, respectively. As such, the insulating material solution 30 remaining on the tab portion may be removed. Therefore, after the dip coating process, primary drying may be performed to stabilize the insulating coating part 30a, and then, a cleaning process may be performed.

As illustrated in FIG. 3C, the jelly roll 200 or the stack 200′ on which the insulating coating part 30a is formed may be immersed in a container containing a cleaning material 50 to clean portions of the negative electrode tabs 210 and 210′ and the positive electrode tabs 220 and 220′. In some embodiments, only the portions of the negative electrode tabs 210 and 210′ and the positive electrode tabs 220 and 220′, which do not require the insulation, may be immersed to be cleaned. In some embodiments, due to a difference in length between the negative electrode tabs 210 and 210′ and the positive electrode tabs 220 and 220′, portions of the areas of the non-coating portions of the negative electrode tabs 210 and 210′ may be cleaned together. However, in the case of the positive electrode tabs 220 and 220′, the insulating coating part 30a may remain on portions of the positive electrode tabs 220 and 220′, which are connected to the non-coating portions. Dimethyl carbonate (DMC) or the like may be used as the cleaning material 50. The kind of cleaning material 50 may not be limited thereto, as long as the material melts and/or removes the insulating material solution 30 without damaging the tabs. When the cleaning of the tab portion is completed, the insulating coating of the jelly roll 200 or the stack 200′ may be completed through a secondarily drying process.

As described above, when the insulating material is applied to the electrode assembly, the entire electrode assembly may be applied at once without applying the insulating material to the negative electrode plate, the positive electrode plate, and the separator one by one, and thus, the production rate may be significantly improved.

According to some embodiments, when the insulating material is applied to the electrode assembly, the insulating material may be applied to the entire electrode assembly at once, without individually applying the insulating material to the negative electrode plate, the positive electrode plate, and the separator one by one, and thus, the production rate may be significantly improved.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A method for manufacturing a secondary battery, comprising:
an electrode assembly formation process in which a unit stack is wound or stacked to form an electrode assembly;
a coating process in which an area of a non-coating portion comprising a negative electrode tab and a positive electrode tab of the electrode assembly is coated; and
a cleaning process in which the negative electrode tab and the positive electrode tab are cleaned after the coating process.

2. The method as claimed in claim 1, further comprising a drying process in which the electrode assembly is dried after the coating process and the cleaning process.

3. The method as claimed in claim 1, wherein the coating process comprises a dip coating process in which the area of the non-coating portion comprising the negative electrode tab and the positive electrode tab is immersed in an insulating material solution to be coated.

4. The method as claimed in claim 3, wherein the insulating material solution comprises polyimide (PI) or polyamide-imide (PAI).

5. The method as claimed in claim 1, wherein, in the cleaning process, the negative electrode tab and the positive electrode tab are immersed in a cleaning material solution to be cleaned.

6. The method as claimed in claim 5, wherein the cleaning material solution comprises dimethyl carbonate (DMC).

7. A method for manufacturing a secondary battery, comprising:
forming an electrode assembly in which a unit stack is wound or stacked;
coating an area of a non-coating portion comprising a negative electrode tab and a positive electrode tab of the electrode assembly; and
cleaning the negative electrode tab and the positive electrode tab after the coating.

8. The method of claim 7, further comprising drying the electrode assembly after the coating and the cleaning.

9. The method of claim 7, wherein the coating comprises dip coating the area of the non-coating portion comprising the negative electrode tab and the positive electrode tab in an insulating material solution.

10. The method of claim 9, wherein the insulating material solution comprises polyimide (PI) or polyamide-imide (PAI).

11. The method of claim 7, wherein the cleaning comprises immersing the negative electrode tab and the positive electrode tab in a cleaning material solution.

12. The method of claim 11, wherein the cleaning material solution comprises dimethyl carbonate (DMC).
